(19) United States
(12) Patent Application Publication
(10) Pub. No.: US 2025/0170626 A1
(43) Pub. Date: May 29, 2025

(54) Automated Cleaning Of An Optical Element

(71) Applicant: APPLE INC., Cupertino, CA (US)

(72) Inventors: Michael J. Oudenhoven, San Francisco, CA (US); Brian S. Lau, Sacramento, CA (US)

(21) Appl. No.: 18/851,352

(22) PCT Filed: May 3, 2023
(86) PCT No.: PCT/US2023/020775

§ 371 Date: Sep. 26, 2024

Related U.S. Application Data
(60) Provisional application No. 63/343,135, filed on May 18, 2022.

(51) Int. Cl. B08B 11/02; B08B 1/36; B08B 13/00; G02B 27/00

(52) U.S. Cl. CPC B08B 11/02; B08B 1/36; B08B 13/00; G02B 27/0006

(57) ABSTRACT

A device includes a first cleaning element and a second cleaning element positioned opposite the first cleaning element. An optical device can be placed between the first cleaning element and the second cleaning element. A sensor is configured to output a force signal that represents a force applied by the first cleaning element, and a controller is operable to control operation of the first cleaning element based on the force signal.

### CROSS-REFERENCE TO RELATED APPLICATIONS

This application claims the benefit of United States Provisional Application No. 63/343,135, filed on May 18, 2022, the contents of which are hereby incorporated by reference in its entirety for all purposes.

### FIELD

The present disclosure relates generally to the field of cleaning optical devices.

### BACKGROUND

An optical device that is wearable by a user may include one or more lenses through which the user can view content and/or the surrounding environment. In some instances, manually cleaning the lenses can cause damage to the lenses and/or other components of the optical device.

### SUMMARY

One aspect of the disclosure is a device that includes a first cleaning element and a second cleaning element positioned opposite the first cleaning element. An optical device can be placed between the first cleaning element and the second cleaning element. A sensor is configured to output a force signal that represents a force applied by the first cleaning element, and a controller is operable to control operation of the first cleaning element based on the force signal.

Another aspect of the disclosure is a device for cleaning a lens assembly that includes a housing that defines a lens receiving portion configured to receive the lens assembly. A first cleaning element is positioned on a first side of the lens assembly, is configured to contact a first side of the lens assembly, and includes a bladder configured to hold a gas. A sensor is coupled to the bladder and is configured to output a signal that represents a pressure of the gas in the bladder. A second cleaning element is positioned on a second side of the lens assembly and is configured to contact the second side of the lens assembly. A controller is operable to control operation of the first cleaning element based on the pressure.

Yet another aspect of the disclosure is a cleaning device that includes a lens receiving portion that is configured to receive a lens assembly. The lens assembly includes a first lens, a second lens, and a waveguide that are assembled in a stacked configuration where the first lens is positioned opposite the second lens, and the waveguide is positioned between the first lens and the second lens. A first cleaning element is configured to contact and conform to the first lens, and a second cleaning element is configured to contact and conform to the second lens. A controller is configured to control operation of the first cleaning element and the second cleaning element in a manner that limits deformation of the first lens and the second lens relative to the waveguide.

### BRIEF DESCRIPTION OF THE DRAWINGS

FIG. 1 is an illustration of a top view of a cleaning device with cleaning elements in a stored configuration.

FIG. 2 is an illustration of another top view of the cleaning device of FIG. 1 with the cleaning elements in a deployed configuration.

FIG. 3 is an illustration of a cross-section of the cleaning device of FIG. 2 taken across A-A.

FIG. 4 is an illustration of another cross-section of the cleaning device of FIG. 2 taken across B-B.

FIG. 5 is a schematic diagram of a controller.

FIG. 6 is a flowchart that shows a process for cleaning an optical device.

### DETAILED DESCRIPTION

The disclosure herein relates to optical devices that can be worn by a user (e.g., wearable devices). Optical devices can include one or more lenses through which the user views content via a display system and/or the surrounding environment. Under typical use conditions, the lenses may become smudged, attract dust and/or dirt, etc., and to remove the smudges, dirt, and/or dust, the user must clean the lenses. In some instances, when a user manually cleans the lenses using a cloth or other cleaning implement, the lenses may be damaged (e.g., cracked, scratched, etc.). In some instances, the lenses may be damaged from the force applied to the lenses by the user. The lenses may also be damaged by particles on the cloth or cleaning implement that are put in contact with the lenses when the user is cleaning the lenses.

The disclosure herein relates a cleaning device in which a user can place an optical device for automatic cleaning of the lenses of the optical device. The cleaning device may include one or more cleaning elements that are stored within the housing in a stored configuration and are configured to be deployed to contact at least one lens of the optical device and clean the lens. In some implementations, the cleaning element is configured to apply a force to the lens that is lower than a threshold force to avoid breaking the lens or causing the lens to bend and contact other components of the optical device, which may damage the other components.

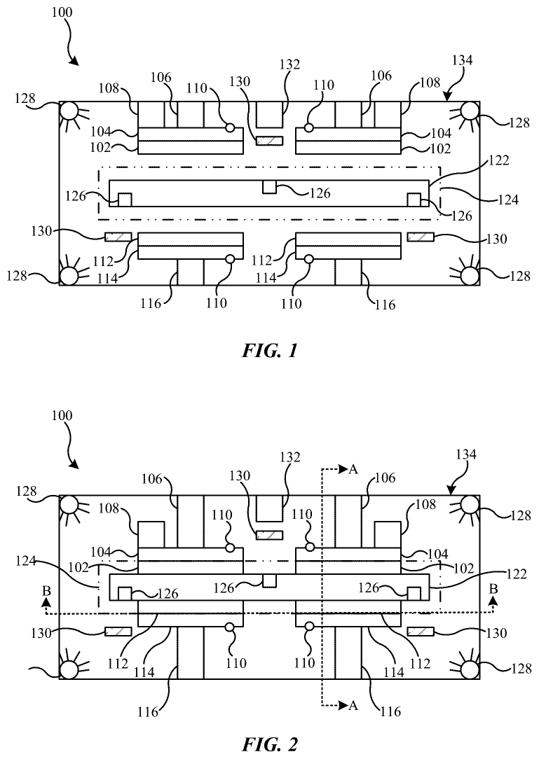

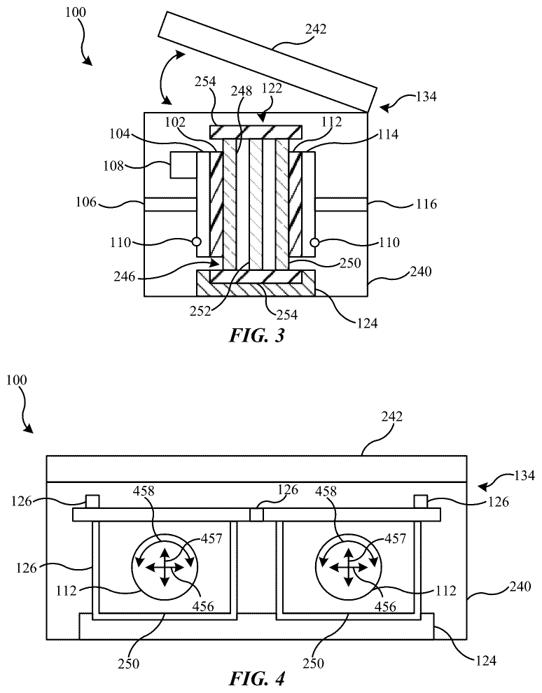

FIG. 1 is an illustration of a top view of a cleaning device 100 with cleaning elements in a stored configuration, and FIG. 2 is an illustration of the top view of the cleaning device 100 with the cleaning elements in a deployed configuration. The cleaning device 100 includes a housing 134 in which the other components of the cleaning device 100 are positioned and/or stored. The housing 134 includes a lens receiving portion 124 that is configured to receive a lens assembly 246 (shown in FIG. 3) of an optical device 122. The optical device 122 can be any type of device that a user can place in front of the eyes of the user that the user can look into and/or through. In some implementations, the optical device 122 is a virtual reality (“VR”) device. The optical device 122 may also be an augmented reality (“AR”) device such as augmented reality glasses. In some embodiments, the optical device 122 may be conventional eyeglasses. In instances where the optical device 122 is an AR or VR type device, the optical device 122 may include a camera 126. The camera 126 may include any type of device that senses and/or records information related to the user and/or the surrounding environment. For example, the camera 126 may be a visible light camera, an infrared camera, a structured light sensor, a time of flight camera, etc. One or more of the cameras 126 can be positioned on the optical device 122. For example, the optical device 122 includes three of the cameras 126 positioned in different locations. More or fewer of the cameras 126 can be used in other implementations. One or more of the cameras 126 can be outward facing such that images captured by the cameras 126 are of the surrounding environment. Furthermore, one or more of the cameras 126 can be inward facing such that images captured by the cameras 126 are of the user (e.g., the user's face, eyes, etc.).

The cleaning device 100 also includes a first cleaning element 102 and a second cleaning element 112 positioned opposite of the first cleaning element 102. As shown, the first cleaning element 102 and the second cleaning element 112 are in a stored configuration in which the first cleaning element 102 and the second cleaning element 112 are separated by a first distance. Accordingly, the first cleaning element 102 and the second cleaning element 112 are configured to allow placement of the optical device 122 between the first cleaning element 102 and the second cleaning element 112 when in the stored configuration.

The first cleaning element 102 and the second cleaning element 112 are similar such that any description of the first cleaning element 102 applies to the second cleaning element 112 and vice versa. The first cleaning element 102 may include surfaces and/or materials configured to clean and/or buff lenses of the optical device 122. For example, the first cleaning element 102 may include a cloth material, a foam material, or any other type of material that can clean and/or buff lenses of the optical device 122. In some implementations, the first cleaning element 102 may be coupled to a backing layer that is more rigid than the first cleaning element 102 such that the first cleaning element 102 conforms to the shape of the backing layer. For example, the first cleaning element 102 may include a cloth material wrapped around a foam disk.

The first cleaning element 102 may be coupled to a first actuator 106, and the second cleaning element 112 may be coupled to a second actuator 116. The first actuator 106 and the second actuator 116 have similar functions such that any description of the first actuator 106 applies to the second actuator 116 and vice versa. The first actuator 106 is coupled to and positioned between the first cleaning element 102 and the housing 134. The first actuator 106 is configured to move the first cleaning element 102 from the stored configuration to a deployed configuration, where the first cleaning element 102 contacts a lens of the optical device 122. Similarly, the second actuator 116 is configured to move the second cleaning element 112 from the stored configuration to the deployed configuration, where the second cleaning element 112 contacts a lens of the optical device 122. Accordingly, the first cleaning element 102 and the second cleaning element 112 are movable between the stored configuration and the deployed configuration. In the stored configuration, the first cleaning element 102 and the second cleaning element 112 are separated by the first distance, and in the deployed configuration, the first cleaning element 102 and the second cleaning element 112 are separated by a second distance that is less than the first distance.

The first actuator 106 may be configured to cause the first cleaning element 102 to move in various directions. For example, the first actuator 106 may cause the first cleaning element 102 to move linearly along a longitudinal axis of the first actuator 106 to move the first cleaning element 102 from the stored configuration to the deployed configuration. Additionally, the first actuator 106 may cause the first cleaning element 102 to move linearly along one or more axes perpendicular to the longitudinal axis of the first actuator 106 (e.g., to impart an up-down and/or side-side motion). Furthermore, the first actuator 106 may cause the first cleaning element 102 to rotate around the longitudinal axis of the first actuator 106. The first actuator 106 may also cause the first cleaning element 102 to rotate around an offset longitudinal axis (e.g., a longitudinal axis that is parallel to the longitudinal axis of the first actuator 106). Rotation around an offset longitudinal axis may cause the first cleaning element 102 and the second cleaning element 112 to rotate eccentrically. Thus, the first cleaning element 102 and the second cleaning element 112 may be configured to rotate eccentrically.

The first actuator 106 may be a single actuator configured to perform the operations described. The first actuator 106 may also include multiple actuators with each actuator configured to perform one or more of the operations described. The first actuator 106 may include one or more servomotors to perform the operations described (e.g., one or more linear and/or continuous rotation servomotors).

In some embodiments, the first cleaning element 102 includes a first bladder 104 and the second cleaning element 112 includes a second bladder 114. The first bladder 104 and the second bladder 114 have similar functions such that any description of the first bladder 104 applies to the second bladder 114. The first bladder 104 may include a flexible material and is configured to hold a gas such that the shape of the first bladder 104 (and therefore the shape of the first cleaning element 102) can conform to a surface when the first bladder 104 is pressed against a surface. For example, when in the deployed configuration, the first bladder 104 and the first cleaning element 102 are configured to contact and conform to a first lens 248 (shown in FIG. 3) of the optical device 122, and the second bladder 114 and the second cleaning element 112 are configured to contact and conform to a second lens 250 (shown in FIG. 3) of the optical device 122. In some implementations, the gas in the first bladder 104 is air. The gas in the first bladder 104 may also include other gases such as nitrogen, oxygen, or any other gas suitable to be held by the first bladder 104.

In some arrangements, each of the first bladder 104 and the second bladder 114 includes, or is fluidly coupled to, a pressure regulation device 110. The pressure regulation device 110 is configured to change (e.g., increase and/or decrease) an amount of gas within the first bladder 104. The pressure regulation device 110 may include a valve that is configured to release a portion of the gas from the first bladder 104 when the pressure of the gas within the first bladder 104 exceeds a threshold value. In embodiments where the pressure regulation device 110 includes a valve, the valve may also be configured to allow gas to enter the first bladder 104. In some implementations, the pressure regulation device 110 may include a piston/cylinder arrangement that is fluidly coupled with the first bladder 104, where the cylinder is configured to store the gas and the piston is configured to move within the cylinder to increase or decrease an amount of gas in the first bladder 104. Other configurations of the pressure regulation device 110 can be implemented that allow for an increase and/or decrease of an amount of gas in the first bladder 104.

In some embodiments, a sensor 108 is coupled to the first bladder 104. The sensor 108 is configured to output a signal that represents a characteristic of the first bladder 104. In some implementations, the sensor 108 is configured to output a force signal that represents a force applied by the first cleaning element 102 to a lens of the optical device 122. In some implementations, the sensor 108 is configured to output a signal that represents a pressure of the gas in the first bladder 104. The sensor 108 can be any type of device or system configured to provide the outputs described.

The cleaning device 100 is further shown to include a fluid dispenser 128. FIG. 1 shows four of the fluid dispensers 128 positioned in different locations of the housing 134, but more or fewer fluid dispensers 128 can be used. The fluid dispenser 128 is configured to apply one or more fluids to the optical device 122. In some implementations, the fluid dispenser 128 is configured to dispense a fluid to clean one or more lenses of the optical device 122. The fluid dispenser 128 may also be configured to dispense fluid to clean other components of the optical device 122, such as a frame, a strap, a head band, or any other component that is a part of or is coupled to the optical device 122. The fluid dispenser 128 may also be configured to dispense a disinfecting fluid to sanitize the optical device 122. As shown in FIG. 1, the fluid dispensers 128 are positioned in the corners of the housing 134, however the fluid dispensers 128 may be positioned in any location within the housing 134 that allows the fluid dispensers 128 to apply fluid to the lenses of the optical device 122.

The cleaning device 100 is further shown to include a reflective component 130. FIG. 1 shows three of the reflective components 130 positioned in different locations of the housing 134, but more or fewer reflective components 130 may be used. The reflective components 130 are configured to reflect light from one or more lenses of the optical device 122 to at least one of the cameras 126, such that an image of one or more lenses of the optical device 122 is captured by the cameras 126. The reflective component 130 may be a mirror, reflective glass, or any other type of material that is configured to reflect an image of one or more lenses of the optical device 122 to the cameras 126.

A controller 132 is located in the housing 134, is electrically coupled with, and is operable to control operation of, at least some of the components of the cleaning device 100. For example, the controller 132 is operable to receive signals from the sensor 108 and control operation of the first cleaning element 102 (via the first actuator 106) and the second cleaning element 112 (via the second actuator 116) based on the signal. The signal may be a force signal or may represent a pressure of the gas in the first bladder 104. Accordingly, the controller 132 is operable to control operation of the first cleaning element 102 and the second cleaning element 112 based on the force signal and/or the pressure of the gas in the first bladder 104. The controller 132 is also operable to control operation of the fluid dispensers 128. For example, the controller 132 may control when the fluid dispensers 128 dispense fluid, how much fluid is dispensed, and whether each of the fluid dispensers 128 should dispense fluid (e.g., in some implementations each of the fluid dispensers 128 can be operated independently of the others). The controller 132 may also be operable to control the pressure regulation device 110. For example, the optical device 122 may be configured to withstand a threshold pressure on the first lens 248 and the second lens 250. The controller 132 can determine, based on the force signal(s) received from the sensor 108, the pressure within the first bladder 104. The pressure within the first bladder 104 corresponds to the pressure on a lens of the optical device 122 when the first cleaning element 102 is in contact with a lens of the optical device 122. Accordingly, the controller 132 may be operable to control operation of the pressure regulation device 110 to change an amount of gas within the first bladder 104 such that the pressure of the gas within the first bladder 104 remains below the threshold value.

FIG. 3 is an illustration of a cross-section of the cleaning device 100 of FIG. 2 taken across A-A. The first cleaning element 102 and the second cleaning element 112 are shown in the deployed configuration. The housing 134 is shown to include a bottom portion 240 and a top portion 242. The top portion 242 is movably coupled to the bottom portion 240 such that the housing 134 is movable between an open position and a closed position. In some implementations, the controller 132 (not shown in FIG. 3) is operable to operate the first actuator 106 and the second actuator 116 based on the position of the housing 134. For example, the controller 132 may be operable to deploy the first cleaning element 102 and the second cleaning element 112 when the housing 134 is in the closed position and is operable to store the first cleaning element 102 and the second cleaning element 112 when the housing 134 is in the open position. Accordingly, the first cleaning element 102 and the second cleaning element 112 are configured to be deployed when the housing 134 is in the closed position and are configured to be stored when the housing 134 is in the open position.

The optical device 122 is further shown to include a lens assembly 246 at least partially surrounded by a frame 254. In implementations where the frame 254 surrounds the lens assembly 246, the lens receiving portion 124 is configured to receive the frame 254 that surrounds the lens assembly 246. In implementations where the frame 254 partially surrounds the lens assembly 246, the lens receiving portion 124 is configured to receive the lens assembly 246.

The lens assembly 246 includes a first lens 248, a second lens 250, and a waveguide 252 that are assembled in a stacked configuration where the first lens 248 is positioned opposite the second lens 250, and the waveguide 252 is located between the first lens 248 and the second lens 250. The first lens 248 and the second lens 250 are configured to direct light to eyes of a user in a manner that allows the user to view the surrounding environment and/or content on a display. In some implementations, the first lens 248 and the second lens 250 may be corrective lenses that may be configured for use by a specific user. The first lens 248 and the second lens 250 may be formed from molded transparent plastic, glass, or other transparent material through which the user can see. The first lens 248 and the second lens 250 may be formed in any shape, such as generally cylindrical, oval, rounded rectangle, or irregular. The waveguide 252 is configured to receive light from the second lens 250 and direct the light through the first lens 248 toward the eyes of the user.

Assembled as described, the first cleaning element 102 is positioned on a first side of the lens assembly 246 (e.g., on the same side as the first lens 248) and the second cleaning element 112 is positioned on a second side of the lens assembly 246 (e.g., on the same side as the second lens 250). The controller 132 is configured to direct the first actuator 106 to cause the first cleaning element 102 to contact the first lens 248 and to direct the second actuator 116 to cause the second cleaning element 112 to contact the second lens 250 (e.g., to cause the first cleaning element 102 and the second cleaning element 112 to move from the stored configuration to the deployed configuration). Therefore, the first cleaning element 102 and the second cleaning element 112 are configured to contact the optical device 122 (e.g., the first cleaning element 102 is configured to contact the first side of the lens assembly 246 and the second cleaning element 112 is configured to contact the second side of the lens assembly 246) when in the deployed configuration.

The lens assembly 246 may be arranged where there is a first gap between the first lens 248 and the waveguide 252 that defines a first distance between the first lens 248 and the waveguide 252. A second gap between the second lens 250 and the waveguide 252 defines a second distance between the second lens 250 and the waveguide 252. In some embodiments, the first distance and the second distance are the same, however the first distance and the second distance may also be different.

In some implementations, the first lens 248 and the second lens 250 flex inward (e.g., deform) toward the waveguide 252 when the first cleaning element 102 contacts the first lens 248 and the second cleaning element 112 contacts the second lens 250. If one or more of the first lens 248 and the second lens 250 contact the waveguide 252, it is possible for the waveguide 252 to crack, break, or otherwise be damaged by the contact. Accordingly, the controller 132 is configured to operate the first cleaning element 102 and the second cleaning element 112 in a manner that limits deformation of the first cleaning element 102 and the second cleaning element 112 relative to the waveguide 252. For example, the controller 132 may be configured to adjust and/or stop operation of the first cleaning element 102 to maintain at least a first threshold distance between the first cleaning element 102 and the waveguide 252. In some implementations, the first threshold distance may be greater than zero but less than the first distance. Furthermore, the controller 132 may be configured to adjust and/or stop operation of the second cleaning element 112 to maintain at least a second threshold distance between the second cleaning element 112 and the waveguide 252. In some implementations, the second threshold distance may be greater than zero but less than the second distance. Because the controller 132 directs the first actuator 106 and the second actuator 116 to cause the first cleaning element 102 and the second cleaning element 112 to contact the first lens 248 and the second lens 250, respectively, the controller 132 is configured to control operation of the first actuator 106 and/or the second actuator 116 based on the first threshold distance and the second threshold distance.

In some implementations, the force applied to the first lens 248 by the first cleaning element 102 and the force applied to the second lens 250 by the second cleaning element 112 are related to the first distance and the second distance, respectively. For example, a higher force applied to the first lens 248 will result in a larger flex of the first lens 248 as compared to a flex of the first lens 248 when a lower force is applied to the first lens 248. Additionally, a higher force applied to the second lens 250 will result in a larger flex of the second lens 250 as compared to a flex of the second lens 250 when a lower force is applied to the second lens 250. As the flex of the first lens 248 and the second lens 250 increases, the first distance and the second distance decrease. The value of the force applied to the first lens 248 that causes the first lens 248 to contact the waveguide 252 is the first threshold force value. The value of the force applied to the second lens 250 that causes the second lens 250 to contact the waveguide 252 is the second threshold force value. Accordingly, the first threshold distance corresponds to a force signal that indicates the first threshold force is applied to the first lens 248 by the first cleaning element 102, and the second threshold distance corresponds to a force signal that indicates the second threshold force is applied to the second lens 250 by the second cleaning element 112. Furthermore, because force and pressure are related (e.g., pressure is equal to the force divided by the area over which the force is acting), the first threshold distance also corresponds to a first threshold pressure of the gas in the first bladder 104 and the second threshold distance also corresponds to a second threshold pressure of the gas in the second bladder 114.

The controller 132 may be configured to operate, adjust, and/or stop operation of the first cleaning element 102 and the second cleaning element 112 based on the force signal. For example, the controller 132 may be operable to cause the first cleaning element 102 and/or the second cleaning element 112 to operate when the force signal indicates that the force applied by the first cleaning element 102 is below the first threshold force value and/or that the force applied by the second cleaning element 112 is below the second threshold force value. Additionally, the controller 132 may be configured to stop operation of the first cleaning element 102 and the second cleaning element 112 when the force signal indicates that the force applied by the first cleaning element 102 and/or the second cleaning element 112 exceeds the first threshold force value and/or the second threshold force value. Furthermore, the controller 132 may be configured to adjust operation of the first cleaning element 102 and the second cleaning element 112 based on the first threshold force value and/or the second threshold force value. For example, if the force signal indicates that the force applied by the first cleaning element 102 and/or the second cleaning element 112 is approaching the first threshold force value and/or the second threshold force value, the controller 132 may be configured to adjust operation of the first cleaning element 102 and/or the second cleaning element 112 so the force applied by the first cleaning element 102 and/or the second cleaning element 112 does not exceed the first threshold force value and/or the second threshold force value.

Because force and pressure are related, the controller 132 can also operate, adjust, and/or stop operation of the first cleaning element 102 and the second cleaning element 112 based on the pressure of the gas in the first bladder 104 and the second bladder 114. For example, the controller 132 may be operable to cause the first cleaning element 102 and/or the second cleaning element 112 to operate when the pressure of the gas in the first bladder 104 is below the first threshold pressure value and/or when the pressure of the gas in the second bladder 114 is below the second threshold pressure value. Additionally, the controller 132 may be configured to stop operation of the first cleaning element 102 and the second cleaning element 112 when the pressure of the gas in the first bladder 104 and/or the second bladder 114 exceeds the first threshold pressure value and/or the second threshold pressure value. Also, if the pressure of the gas in the first bladder 104 and/or the second bladder 114 is approaching the first threshold pressure value and/or the second threshold pressure value, the controller 132 may be configured to adjust operation of the first cleaning element 102 and/or the second cleaning element 112 so the pressure in the first bladder 104 and/or the second bladder 114 does not exceed the first threshold pressure value and/or the second threshold pressure value.

FIG. 4 is an illustration of another cross-section of the cleaning device 100 of FIG. 2 taken across B-B. As shown, motion of the second cleaning element 112 is indicated by a generally horizontal arrow 456, a generally vertical arrow 457, and a generally circular arrow 458. Accordingly, during operation of the second cleaning element 112, the second cleaning element 112 can be moved by the second actuator 116 in a generally vertical direction that corresponds to the generally vertical arrow 457, in a generally horizontal direction that corresponds to the generally horizontal arrow 456, and in a generally circular direction (e.g., rotation) that corresponds to the generally circular arrow 458. In some implementations, the second actuator 116 can move the second cleaning element 112 in each direction simultaneously (e.g., moving the second cleaning element 112 linearly toward a corner of the second lens 250 while rotating the second cleaning element 112). Operating in the manner described, the controller 132 is configured to direct the second actuator 116 to move the second cleaning element 112 around the second lens 250 while the second cleaning element 112 is in contact with the second lens 250 to clean the second lens 250. Though the above description of FIG. 4 was directed to the second cleaning element 112, the second actuator 116, and the second lens 250, the description also applies to the first cleaning element 102, the first actuator 106, and the first lens 248.

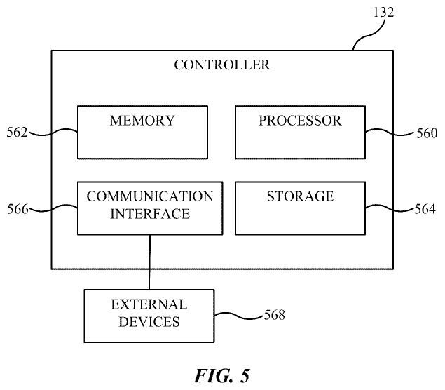

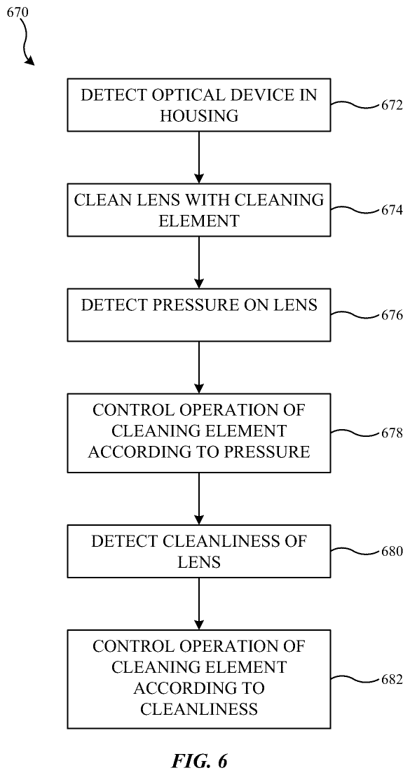

FIG. 5 is a schematic diagram of the controller 132. The controller 132 may be used to implement the systems and methods disclosed herein. For example, the controller 132 may receive data related to the force signal and/or gas pressure from the sensor 108 and control operation of the first actuator 106 and/or the second actuator 116 to operate the first cleaning element 102 and the second cleaning element 112. In an example hardware configuration, the controller 132 generally includes a processor 560, a memory 562, a storage 564, and a communications interface 566. The processor 560 may be any suitable processor, such as a central processing unit, for executing computer instructions and performing operations described thereby. The memory 562 may be a volatile memory, such as random-access memory (RAM). The storage 564 may be a non-volatile storage device, such as a hard disk drive (HDD) or a solid-state drive (SSD). The storage 564 may form a computer readable medium that stores instructions (e.g., code) executed by the processor 560 for operating external devices 568, for example, in the manners described above and below. The communications interface 566 is in communication with, for example, the external devices 568, for sending to and receiving from various signals (e.g., control signals and/or notifications). The external devices 568 may include, for example, the first actuator 106, the second actuator 116, the sensor 108, and the cameras 126. The external devices 568 may also include, for example, devices external to the housing 134 such as a mobile device (smart phone, tablet computer, etc.), a server, a display system, etc.

FIG. 6 is a flowchart that shows a process 670 for cleaning the optical device 122. The process 670 can be implemented at least in part by the controller 132. At operation 672, an optical device is detected in the housing 134. For example, the housing 134 may include an additional sensor configured to generate a signal in response to the optical device 122 being positioned in the housing 134 by the user. The additional sensor may include a force sensor (e.g., to detect an increase in force on the lens receiving portion 124 when the optical device 122 is positioned in the housing 134), a beam sensor (e.g., to detect a break in the beam when the optical device 122 is positioned in the housing 134), and/or one or more cameras. Upon loading the optical device 122 in the lens receiving portion 124, the additional sensor sends a signal to the controller 132 that indicates the optical device 122 is loaded in the housing 134.

At operation 674, a lens is cleaned with a cleaning element. For example, after the user closes the top portion 242 of the housing 134, the controller 132 may direct the fluid dispensers 128 to spray cleaning fluid on the first lens 248 and the second lens 250. The controller 132 may also direct the first actuator 106 to cause the first cleaning element 102 to contact the first lens 248. The controller 132 may also direct the first actuator 106 to cause the first cleaning element 102 to rotate and move horizontally and vertically while in contact with the first lens 248 to clean the first lens 248. The controller 132 may also direct the second actuator 116 to cause the second cleaning element 112 to contact the second lens 250 and direct the second actuator 116 to cause the second cleaning element 112 to clean the second lens 250 in the same manner as described with respect to the first cleaning element 102.

At operation 676, a pressure on a lens is detected. For example, during operation of the first cleaning element 102 and the second cleaning element 112, the sensor 108 generates a force signal that is provided to the controller 132. In some implementations, the sensor 108 converts the force signal to a pressure signal and provides the pressure signal to the controller 132. The controller 132 may determine the pressure of the gas in the first bladder 104 and/or the second bladder 114 based on the pressure signal. The controller 132 may also determine the pressure of the gas in the first bladder 104 and/or the second bladder 114 based on the force signal.

At operation 678, operation of the cleaning element is controlled according to pressure. For example, if the detected pressure is less than the threshold pressure value (e.g., less than the first threshold pressure and the second threshold pressure), the controller 132 continues to operate the first actuator 106 and the second actuator 116. In some embodiments, the controller 132 may cause the pressure regulation device 110 to add gas to the first bladder 104 and/or the second bladder 114 to increase the pressure of the gas in the first bladder 104 and/or the second bladder 114. If the detected pressure is approaching the threshold pressure value (e.g., within ten percent of threshold pressure value), the controller 132 may change operation of the first actuator 106 and the second actuator 116 to reduce the pressure. In some implementations, the controller 132 may cause the pressure regulation device 110 to allow a portion of the gas within the first bladder 104 and/or the second bladder 114 to escape to reduce the pressure of the gas. If the detected pressure is greater than the threshold pressure value, the controller 132 may stop operation of the first actuator 106 and the second actuator 116 and move the first cleaning element 102 and the second cleaning element 112 to the stored configuration.

At operation 680, the cleanliness of the lens is detected. For example, after the cleaning cycle is complete, the controller 132 directs the first actuator 106 and the second actuator 116 to move the first cleaning element 102 and the second cleaning element 112 to the stored configuration. One or more of the cameras 126 may capture images of the first lens 248 and the second lens 250. In some implementations, the cameras 126 capture images directly (e.g., the cameras 126 are oriented toward the first lens 248 and/or the second lens 250). In some implementations, the cameras 126 capture images indirectly (e.g., the reflective components 130 are positioned to reflect an image of the first lens 248 and/or the second lens 250 toward the cameras 126 so the cameras 126 can capture an image of the first lens 248 and/or the second lens 250).

At operation 682, operation of the cleaning element is controlled according to the cleanliness of the lens. For example, the captured images are analyzed by the controller 132 and the controller 132 determines whether the first lens 248 and the second lens 250 are clean (e.g., generally free from smudges, dust particles, etc.). If the controller 132 determines that one or more of the first lens 248 and the second lens 250 are not clean, the controller 132 can direct the first actuator 106 and/or the second actuator 116 to cause the first cleaning element 102 and/or the second cleaning element 112 to clean the portion that is not clean.

In addition to the embodiments described above, the system and methods disclosed herein can be implemented in various other configurations. For example, though the above description was related to cleaning glasses, any device that includes lenses can be cleaned with the disclosed system. Devices with lenses include, but are not limited to, goggles, scientific instruments (e.g., magnifying glasses, telescope, etc.), and head mounted devices (e.g., a virtual reality headset).

Furthermore, the system and methods described herein can be used to accomplish other tasks related to the optical device 122. For example, the housing 134 may also be configured as a charging device that can charge a battery coupled to the optical device 122. The controller 132 may also be configured to perform calibration operations on the optical device 122 (e.g., calibrating the cameras 126, the pressure regulation device 110, the first cleaning element 102, the second cleaning element 112, the first actuator 106, the second actuator 116, the sensor 108, etc.) and perform firmware updates when the optical device 122 is in the housing 134.

In addition, data related to the cleaning operation can be provided to the user via the user's mobile device (e.g., how often the optical device 122 is cleaned, how clean the optical device 122 is, etc.). In some implementations, the controller 132 may suggest that the user (via the user's mobile device) choose a predefined cleaning profile and/or schedule for cleaning the optical device 122. The user may also choose a desired cleanliness level and the controller 132 is configured to operate the first actuator 106 and/or the second actuator 116 to achieve the desired cleanliness level.

In some implementations, the cleaning device 100 is configured to determine cleanliness of the optical device 122 and clean the optical device 122 if the cleanliness of the optical device 122 is below a threshold cleanliness. The threshold cleanliness can be defined by the cleaning device 100 or the user. The cleaning device 100 may also be configured to determine the wear habits of the user and avoid cleaning the optical device 122 during a time when the user may choose to wear the optical device 122. For example, if the user typically wears the optical device 122 between 1:00 PM and 2:00 PM, the cleaning device 100 may refrain from cleaning the optical device 122 during that time even if the optical device 122 is positioned within the housing 134 during that time.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create three-dimensional or spatial audio environment that provides the perception of point audio sources in three-dimensional space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As described above, one aspect of the present technology is the gathering and use of data available from various sources for use during operation of the cleaning device 100. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores cleanliness profile related information that allows operation of the cleaning device 100 according to user preferences. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for cleaning the optical device 122, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, desired cleanliness levels may be determined each time the cleaning device 100 is used, such as by entering information on the user's mobile device that is in communication with the cleaning device 100, and without subsequently storing the information or associating with the particular user.

What is claimed is:

1. A device, comprising:
a first cleaning element;
a second cleaning element positioned opposite the first cleaning element and configured to allow placement of an optical device between the first cleaning element and the second cleaning element;
a sensor configured to output a force signal that represents a force applied by the first cleaning element; and
a controller operable to control operation of the first cleaning element based on the force signal.

2. The device of claim 1, wherein the first cleaning element and the second cleaning element are movable between a stored configuration, in which the first cleaning element and the second cleaning element are separated by a first distance, and a deployed configuration, in which the first cleaning element and the second cleaning element are separated by a second distance that is less than the first distance.

3. The device of claim 2, wherein the first cleaning element and the second cleaning element are configured to contact the optical device in the deployed configuration.

4. The device of claim 2, wherein the first cleaning element is coupled to a first actuator configured to move the first cleaning element from the stored configuration to the deployed configuration.

5. The device of claim 4, wherein the second cleaning element is coupled to a second actuator to move the second cleaning element from the stored configuration to the deployed configuration.

6. The device of claim 4, wherein the first actuator causes the first cleaning element to move linearly.

7. The device of claim 4, wherein the first actuator causes the first cleaning element to rotate.

8. The device of claim 2, further comprising a housing movable between an open position and a closed position, wherein the first cleaning element is configured to be deployed when the housing is in the closed position and is configured to be stored when the housing is in the open position.

9. The device of claim 1, wherein the controller is configured to stop operation of the first cleaning element and the second cleaning element when the force signal indicates that the force applied by the first cleaning element exceeds a threshold force value.

10. The device of claim 1, wherein the controller is configured to adjust operation of at least one of the first cleaning element and the second cleaning element so that the force applied by the first cleaning element is below a threshold force value.

11. A device for cleaning a lens assembly, comprising:
a housing defining a lens receiving portion configured to receive the lens assembly;
a first cleaning element positioned on a first side of the lens assembly, configured to contact the first side of the lens assembly, and including a bladder configured to hold a gas;
a sensor coupled to the bladder and configured to output a signal that represents a pressure of the gas in the bladder;
a second cleaning element positioned on a second side of the lens assembly and configured to contact the second side of the lens assembly; and
a controller operable to control operation of the first cleaning element based on the pressure.

12. The device of claim 11, wherein the bladder includes a valve configured to release a portion of the gas from the bladder when the pressure exceeds a threshold pressure value.

13. The device of claim 11, wherein the first cleaning element is coupled to a first actuator configured to rotate the first cleaning element, and the second cleaning element is coupled to a second actuator configured to rotate the second cleaning element.

14. The device of claim 13, wherein the first cleaning element and the second cleaning element are configured to rotate eccentrically.

15. The device of claim 11, further comprising a pressure regulation device fluidly coupled to the bladder, wherein the controller is configured to control operation of the pressure regulation device to change an amount of the gas within the bladder.

16. The device of claim 11, wherein the controller is operable to cause the first cleaning element and the second cleaning element to operate when the pressure of the gas in the bladder is below a threshold pressure value.

17. The device of claim 11, wherein the controller is configured to adjust operation of the first cleaning element and the second cleaning element so that the pressure of the gas in the bladder is below a threshold pressure value.

18. A cleaning device, comprising:
a lens receiving portion configured to receive a lens assembly that includes a first lens, a second lens, and a waveguide assembled in a stacked configuration where the first lens is positioned opposite the second lens, and the waveguide is located between the first lens and the second lens;
a first cleaning element configured to contact and conform to the first lens;
a second cleaning element configured to contact and conform to the second lens; and
a controller configured to control operation of the first cleaning element and the second cleaning element in a manner that limits deformation of the first lens and the second lens relative to the waveguide.

19. The cleaning device of claim 18, wherein the controller is further configured to control operation of the first cleaning element and the second cleaning element to maintain at least a first threshold distance between the first lens and the waveguide and to maintain at least a second threshold distance between the second lens and the waveguide.

20. The cleaning device of claim 19, wherein the controller is configured to direct an actuator to cause the first cleaning element to contact the first lens and to cause the second cleaning element to contact the second lens, and the controller is configured to control operation of the actuator based on the first threshold distance and the second threshold distance.
